(19) United States
(12) Patent Application Publication
(10) Pub. No.: US 2015/0199380 A1
(43) Pub. Date: Jul. 16, 2015

(54) DISCOVERY OF VIEWSHEDS AND VANTAGE POINTS BY MINING GEO-TAGGED DATA

(71) Applicant: Microsoft Corporation, Redmond, WA (US)

(72) Inventors: Vanya Avramova, Bellevue, WA (US); Christopher Alme, Seattle, WA (US); Emmanouil Koukoumidis, Bellevue, WA (US); Norm Bryar, Seattle, WA (US); Anthony Bice, Seattle, WA (US); Arjun Sundararajan, Bellevue, WA (US); Mohamed H. Ali, Kirkland, WA (US)

(73) Assignee: Microsoft Corporation, Redmond, WA (US)

(21) Appl. No.: 14/156,651

(22) Filed: Jan. 16, 2014

(51) Int. Cl. G06F 17/30

(52) U.S. Cl. CPC G06F 17/30241; G06F 17/30312

(57) ABSTRACT

Architecture that obtains and utilizes collections of geographically-tagged data to discover optimal vantage points for viewsheds of entities of interest such as physical entities and conceptual entities such as landmarks, sunset, skyline, etc. The disclosed architecture discloses the utilization of at least geo-tagged image data to discover relationships between a combination of concrete entities and/or abstract concepts, and techniques for surfacing such relationships to users. The data can be crowd-sourced geo-tagged image data that are mined from social content and which can be observed or experienced from a certain location/area.

### BACKGROUND

Most large cities have iconic landmarks that are on the “to do” list of tourists visiting the city. Lists of these landmarks and associated locations are easily available online or on printed paper. What is not available, however, are the vantage points to survey these landmarks, where a user can take great pictures of the landmark, or generally, the relationships between this landmark and other locations/areas and the conditions under which such relationships are active.

This coveted information is usually subject to local community knowledge and not easily discoverable through the conventional sources available to people unfamiliar with the city. Moreover, it is the type of information that people do not know they would want or need before visiting, yet would be valuable to learn about before the visit.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture obtains and utilizes collections (e.g., crowd-sourced) geographically-tagged data (documents tagged with geographical location information, or “geo-tagged” documents such as images) to discover optimal vantage points for viewsheds of entities of interest such as physical entities and conceptual entities. Physical entities can be landmarks and other points of interest, and abstract concepts can be the sunset, waterfront, skyline, street art, thunderstorm, meteor shower, etc., which do not necessarily have an associated physical location.

The disclosed architecture discloses the utilization of at least geo-tagged image data to discover relationships between a combination of concrete entities and/or abstract concepts, and techniques for surfacing such relationships to users. More specifically this includes the utilization of crowd-sourced geo-tagged image data to discover vantage points for viewsheds, for both existing entities and abstract concepts (e.g., sunset, “romantic” views, etc.) that are mined from social content and which can be observed or experienced from a certain location/area.

The architecture also detects the conditions under which such relationships are active (would affect the user experience positively, negatively, or have no effect at all). The vantage point relationships can be also at the same time, a function of external factors such as time of the day, day of the week, season of the year (e.g., summer versus winter), weather conditions, traffic conditions, construction conditions, etc. For example, a given vantage point may no longer be viable when there is fog or the vantage point is quite distant from the viewshed to inhibit a good view. Similarly, some venues may not be sufficiently lit or lit at all, at night. Thus, a vantage point relationship between two locations may only hold based on certain conditions, such as only for specific hours of the day, etc.

The architecture can also augment the vantage point information (or any relationship, in general) with popularity scores based on the number of geo-tagged data that refer to this vantage point, as well as the credibility of the user that produced this data (e.g., the geo-tagged data of a professional photographer has higher credibility than a non-professional person).

The architecture can also augment the relationships with emotional scores derived from the text of the geo-tagged data (e.g., higher score for a vantage point that receives comments such as “Amazing view of the Space Needle” versus “Good view of the Space Needle”).

The architecture can also construct hybrid entity (physical and abstract concept) graphs, and visualize this structure to the user so the user can navigate through the structure to discover new entities (e.g., places to visit, and abstract concepts).

The architecture facilitates the serendipitous discovery of entities to view/visit/observe by pushing recommendations to the user. The recommendations can be based on mined relationships and honor mined conditions for such relationships. For example, while the user is on a ferry to a specific destination, the architecture may recommend to the user that when at a specific location to look left at one-hundred twenty degrees to see a breathtaking view of a mountain. The conditions may be that the recommendation is only made if the sky is clear (a weather-based condition) and if the user is a tourist/visitor (a user interest group condition).

The architecture also generates recommendations to the user of related entities (e.g., concepts) while exploring/searching a specific entity. For example, while the user is searching for a specific trip (e.g., a cruise) using a search engine, and while the user is still at home, a recommendation can be generated and presented as to other entities that relate to that trip (e.g., the chance to have a great view of a mountain and a beach).

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system that discovers viewsheds and vantage points in accordance with the disclosed architecture.

FIG. 2 illustrates an alternative system that discovers viewsheds and vantage points in accordance with the disclosed architecture.

FIG. 3 illustrates a flow diagram for generating viewshed clusters.

FIG. 4 illustrates a map for the mining of viewsheds and vantage points for a landmark entity such as the Space Needle using geo-tagged photo data.

FIG. 5 illustrates a map for the mining of viewsheds and vantage points for a concept entity based on geo-tagged “bird” data.

FIG. 6 illustrates a graph that can be constructed based on term frequency histograms generated.

FIG. 7 illustrates a method in accordance with the disclosed architecture.

FIG. 8 illustrates an alternative method in accordance with the disclosed architecture.

FIG. 9 illustrates a block diagram of a computing system that executes the discovery of viewsheds and vantage points by mining geo-tagged Data in accordance with the disclosed architecture.

### DETAILED DESCRIPTION

Knowledge of the best view (e.g., photographic) or vantage points from which to view objects and points of interest (referred to as viewsheds), is desirable, especially for users who visit a location infrequently. Such information has a high user delight factor when presented at the right opportunity, and can be used in any neo-geography scenarios aiming to please users by suggesting things to do and places to visit, in a city.

For example, the Space Needle is an iconic landmark in Seattle. Standing right by the Space Needle, however, will not produce the iconic images people normally associate with this landmark. Unveiling the spots in Seattle where the locals take pictures of the Space Needle can greatly enhance the experience of a newcomer who wants to capture precious shots and memories. Another example is discovering vantage points for more abstract concepts that users would be interested in, such as great places to view the sunset, bird watching, street art, etc. At the same time, the conditions under which the relationships between a set of entities/concepts hold, need to be mined and become available to users. For example, the relationship “place A is a great vantage point of place B” may be active only during specific times of the day (e.g., only during the daylight hours) or only in specific weather conditions (e.g., a clear sky is needed to see Mount Rainer).

The disclosed architecture obtains and utilizes crowd-sourced geographically-tagged data (documents tagged with geographical location information, or “geo-tagged” documents such as images) to discover optimal vantage points for viewsheds of physical and conceptual entities, where physical entities can be landmarks and other points of interest, and vantage points for viewsheds of abstract concepts such as the sunset, waterfront, skyline, street art, thunderstorm, meteor shower, etc., which do not necessarily have an associated physical location.

By applying word similarity measures, concept hierarchies/taxonomies, and user language-locale data, aliases (and misspellings) can be detected, descriptions can be combined or generalized and, tags and names can be localized, thereby enabling response to a user action (e.g., a search for “romantic restaurants”) with related viewsheds (popular sunset views, waterfront views, etc.).

The disclosed architecture discloses the utilization of at least crowd-sourced geo-tagged image data to discover relationships between a combination of concrete entities and/or abstract concepts and a method for surfacing such relationships to users. More specifically this includes the utilization of crowd-sourced geo-tagged image data to discover vantage points for viewsheds, for both existing entities and abstract concepts (e.g., sunset, “romantic” views, etc.) that are mined from social content and which can be observed or experienced from a certain location/area. For example, Alki Beach in Seattle is a vantage point for the Space Needle, as well as Alki Beach being an experience point for the “romantic” and “fresh sea breeze” concepts.

Put another way, the disclosed architecture employs spatial and/or spatio-temporal clustering on user-defined geo-tagged image content, the identification of distinct entities as well as the association of common and related entities and surfacing the same to users, the characterization of entities of interest based on what people have said, the use of concept-graphs to categorize geo-tagged image content, including temporal classification and many-to-many relationships, and the serendipitous discovery of things to view or visit. User profile information and/or inferences (e.g., tourist vs. local resident) can also be incorporated.

The spatial and/or spatio-temporal clustering on user-defined tags can include specific entities (e.g., the ‘Space Needle’) but also more diffuse/abstract concepts (the ‘sunset’, ‘art’, etc.). These may be organized in concept-graphs (e.g., ‘romantic’, ‘autumn’, ‘quirky’, etc.) with many-to-many relationships (e.g. ‘sunset’ is ‘romantic’ and ‘natural beauty’). The architecture assists the user in map-explore experiences, such as helping a user discover the local-character of an area or the serendipitous discovery of things to view or visit.

The architecture also detects the conditions under which such relationships are active (would affect the user experience positively, negatively, or have no effect at all). The vantage points relationships can be also at the same time, a function of external factors such as time of the day, day of the week, season of the year (e.g., summer versus winter), weather conditions, etc. For example, Alki Beach is no longer a vantage point for the Space Needle when there is fog or the vantage point is quite distant from the Space Needle to inhibit a good view. Similarly, some venues may not be sufficiently lit or lit at all, at night. Thus, a vantage point relationship between two locations may only hold based on certain conditions, such as only for specific hours of the day, etc. The architecture can also utilize time-tagged data separately or in combination with the geo-tagged data.

The architecture can also augment the vantage point information (or any relationship, in general) with popularity scores based on the number of geo-tagged data that refer to this vantage point, as well as the credibility of the user that produced this data (e.g., the geo-tagged data of a professional photographer has higher credibility than a non-professional person). Credibility can also be based on whether the “author” (creator of the content, e.g., photograph) is in the social network (e.g., “friended”, “liked”, or other commonly-known social network tags applied by one user to another user) of the user. Additionally, the scoring/presentation can be based on whether the user's friend took the photograph or has been to that location depicted in the photograph.

The architecture can also augment the relationships with emotional scores derived from the text of the geo-tagged data (e.g., higher score for a vantage point that receives comments such as “Amazing view of the Space Needle” versus “Good view of the Space Needle”). Other examples of emotional scores include, but are not limited to, romantic, somber, and more complex attributes beyond just “good” and “amazing”. Additionally, other scores can relate to likes/dislikes and star ratings, where platform support such attributes.

The architecture can also construct hybrid entity and abstract concept graphs, and visualize this structure to the user so the user can navigate through the structure to discover new entities (e.g., places to visit, and abstract concepts).

The architecture facilitates the serendipitous discovery of entities to view/visit/observe by pushing recommendations to the user. The recommendations can be based on mined relationships and honor mined conditions for such relationships. For example, while the user is on a ferry to a specific destination, the architecture may recommend to the user that when at a specific location (e.g., that has a vantage point relationship with Mount Rainer) to look left at one-hundred twenty degrees to see a breathtaking view of Mount Rainer. The conditions may be that the recommendation is only made if the sky is clear (a weather-based condition) and if the user is a tourist/visitor (a user interest group condition).

The architecture also generates recommendations to the user of related entities (e.g., concepts) while exploring/searching a specific entity. For example, while the user is searching for a specific trip (e.g., a cruise to Tillicum Village) using a search engine, and while the user is still at home, a recommendation can be generated and presented as to other entities that relate to that trip (e.g., the chance to have a great view of Mount Rainer and Alki Beach).

The architecture applies machine learning techniques (e.g., clustering) to identify and de-noise geo-tagged data (e.g., image) that is associated with a location-based entity, or an abstract concept-based entity that can be observed from the location-based entity.

Generally, steps are described without specifying the origin of a whitelist (terms that are accepted or approved) of landmarks and concepts (e.g., curated, mined from search-logs, derived from unsupervised learning, etc.) without loss of generality. A given entity (e.g., a landmark or concept) may be known by multiple aliases (combined or “unioned” prior to clustering) or in concept hierarchies (joined post-clustering). Since the processing of images worldwide is expected to use distributed parallelism, stitching clusters (of points) that span grid seams (map gridlines) is recommended. Accordingly, programming models that employ map and reduce functions (e.g., MapReduce) find applicability, where distributed and parallel processing of the map and reduce functions is enabled (e.g., clusters of localized computer nodes and/or geographically distributed grids of computing systems can be employed).

The resulting clusters of data points can be reverse geocoded (translating a point location defined by latitude/longitude coordinates to a readable address or place name) by examining the textual data associated with the given crowd-sourced entries (e.g., tags, comments, messages such as “tweets”, etc.), using reverse geocoder APIs (application programmable interfaces), or a combination of both. Once the clusters have been reverse-geocoded, the resulting locations are assigned as vantage points of the entity of interest (e.g., the original concept or landmark). When the clusters are extracted based on an existing location (e.g., landmark), one of the clusters will likely be the actual landmark itself. The disclosed architecture can be applied to any crowd-sourced data that includes geo-coordinates and a tagged data such as an image.

As an alternative to reverse geocoding, a location can be identified by a more general description such as a sunset vantage point that is just a turn off of a specific road and not represented in the entity set used to reverse geocode. The lat/long (latitude and longitude coordinates) for this location is known to be a good photograph vantage point.

In an alternative implementation, rather than analyze and detect the geo-tagged data, the architecture can operate to simply request users to share their top viewsheds.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

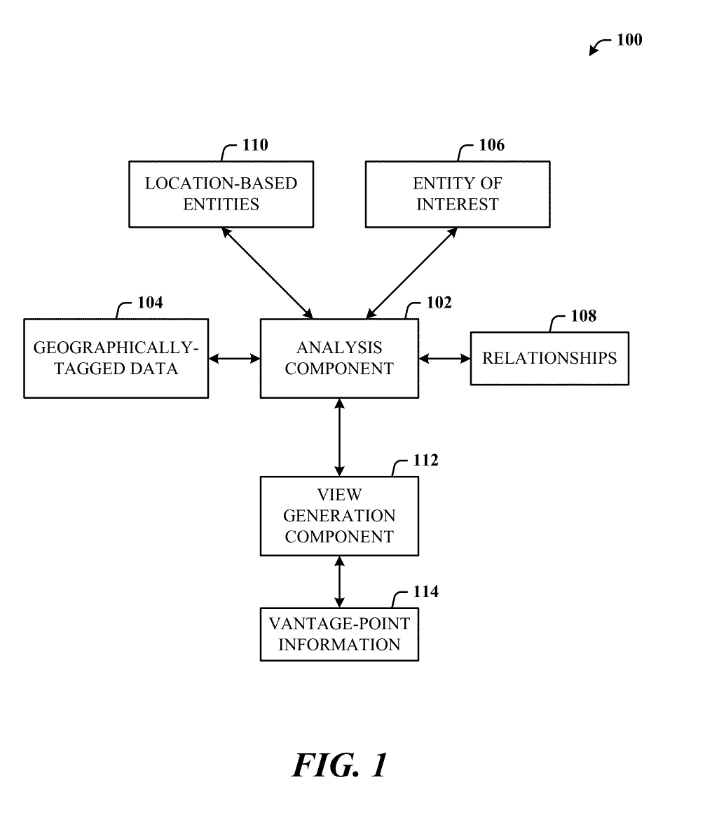

FIG. 1 illustrates a system 100 that discovers viewsheds and vantage points in accordance with the disclosed architecture. The system 100 can include an analysis component 102 configured to analyze geographically-tagged data 104 associated with an entity of interest 106 and discover relationships 108 between location-based entities 110 and the entity of interest 106. The geographically-tagged data can be crowd-sourced image data such as photos made accessible via social networks, for example. The entity of interest 106 can be an object (e.g., landmark, building, etc.) or an abstract concept (e.g., sunset). The system 100 further comprises a view generation component 112 configured to generate vantage-point information 114 from which to view the entity of interest 106 based on the discovered relationships 108.

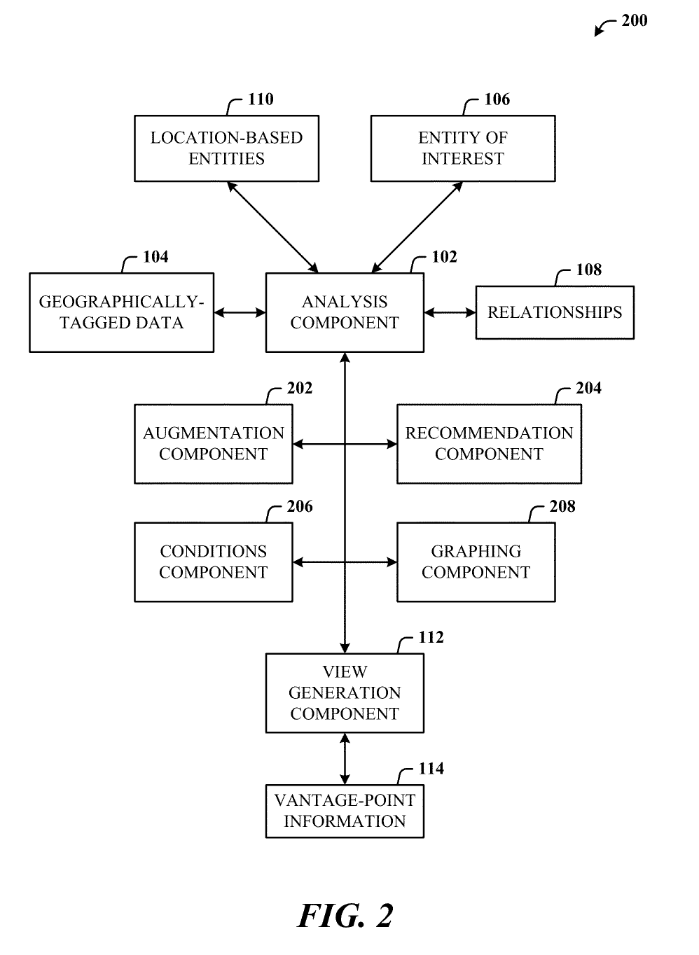

FIG. 2 illustrates an alternative system 200 that discovers viewsheds and vantage points in accordance with the disclosed architecture. The system 200 can comprise one or more of the components of system 100 of FIG. 1, as well as an augmentation component 202, a recommendation component 204, a conditions component 206, and a graphing component 208.

The augmentation component 202 can be configured to augment the vantage-point information with popularity data and source credibility data. Separately or in combination therewith, the augmentation component 202 can be configured to augment the vantage-point information with emotional data derived from an association with the geographically-tagged data.

The recommendation component 204 can be configured to recommend a new entity of interest based on the relationships and relationship conditions, as part of exploring the entity of interest. The conditions component 206 can be configured to detect spatial and/or temporal conditions under which the relationships are active, such as the time of day and location at that time, for example. The graphing component 208 can be configured to generate graphs (e.g., histograms, node-link, etc.) of entities of interest and relationships between the entities of interest to discover new entities. The geographically-tagged data can be obtained from a social network and the analysis component 102 can employ machine-learning techniques to identify and de-noise the geographically tagged data.

Although not shown, the systems 100 and 200 can further comprise a privacy component that enables the authorized and secure handling of user information, such as geographically-tagged image data, for example. The privacy component enables the user to opt-in and opt-out of tracking information as well as personal information that may have been obtained at signup and utilized thereafter. The privacy component also ensures the proper collection, storage, and access to the user information while allowing for the selection and presentation of the content, features, and/or services that assist obtainment the benefits of a richer user experience and to access to more relevant information.

It is to be understood that in the disclosed architecture, certain components may be rearranged, combined, omitted, and additional components may be included. Additionally, in some embodiments, all or some of the components are present on the client, while in other embodiments some components may reside on a server or are provided by a local or remove service.

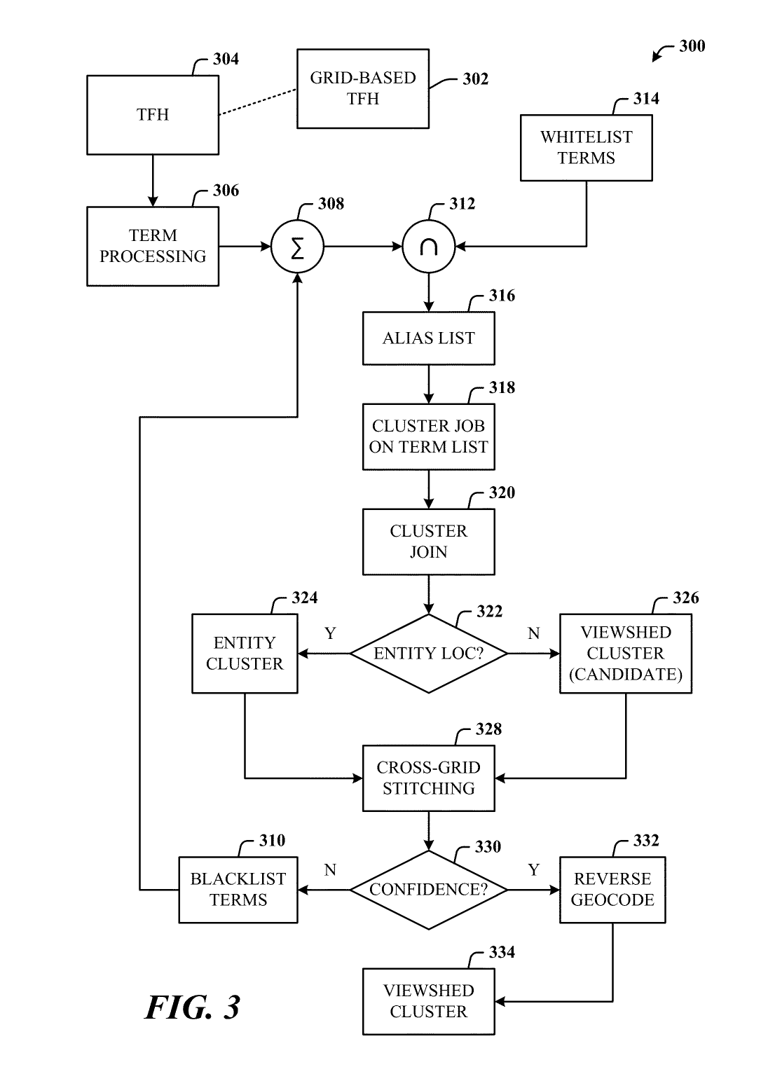

FIG. 3 illustrates a flow diagram 300 for generating viewshed clusters. Initially, grid-based term frequency histograms (TFHs) 302 are received at 304 for processing. Flow is to 306 to perform term processing for semantic similarity using, for example, pairwise term processing (e.g., Levenshtein distance) to determine if terms in the TFH are common misspellings, abbreviations, obscenities, etc. At 308, a blacklist compare operation is performed on the set of terms output from term processing at 306 to remove blacklist terms 310 (unacceptable or denied terms). The backlist terms 310 are updated as part of the process in the diagram 300 and fed back for use on a new set of terms in the TFHs.

Once blacklist processing completes, flow is to 312 to process whitelist terms 314. The whitelist terms 314 are those terms specifically searched or expected to be in the TFH, and boost the confidence in these terms. At 316, alias list processing is performed to find terms that may be shortened versions, slang versions, etc. At 318, clustering is performed on the current state of the term list to find one or more clusters of data points. At 320, a cluster join operation is performed in an attempt to determine if any of the clusters from the previous step can be joined or are distinct collections.

Once the clusters are determined, flow is to 322 to check if the one or more clusters are entity locations. If so, flow is to 324 to identify the cluster as an entity cluster, and if not, flow is to 326 to identify the cluster as a viewshed cluster. In either case, flow is to 328 to then perform cross grid stitching from various types of grid-based machines. At 330, confidence processing is performed. If the confidence is low (below a threshold value), it can be the case that the cluster may be ignored or wait until more data points have been obtained and the confidence is increased before publishing. Optionally, flow can then be to 310 to include terms on the backlist. If the confidence is high (equal and above a threshold value), the cluster points are sent to 332 for reverse geocode processing to identify one or more addresses for each general cluster, or for each data point in the cluster. At 334, the viewshed cluster is output.

Following are examples where each dot on a map represents an individual geo-tagged photo. Similarly depicted dots (e.g., of the same color) fall within the same cluster, Cx, while outlier dots, Oy, are identified as outside a cluster.

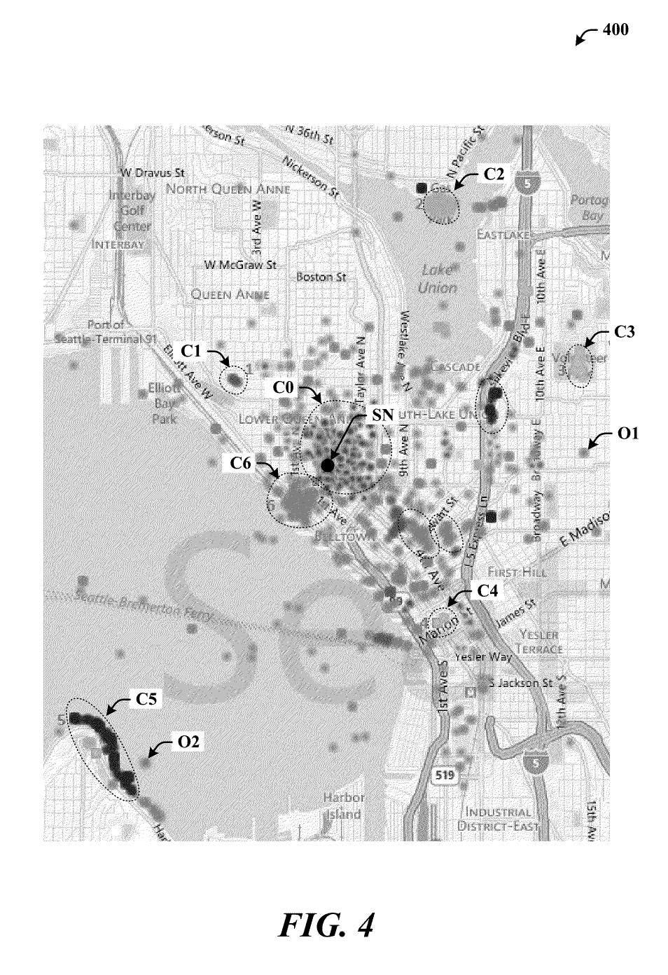

FIG. 4 illustrates a map 400 for the mining of viewsheds and vantage points for a landmark entity such as the Space Needle using geo-tagged photo data. Each dot on the map 400 represents a single instance of photo data. The architecture has identified seven vantage points from which to view the Space Needle (SN): a zeroth vantage point associated with a zeroth cluster C0, a first vantage point associated with a first cluster C1, a second vantage point associated with a second cluster C2, a third vantage point associated with a third cluster C3, a fourth vantage point associated with a fourth cluster C4, a fifth vantage point associated with a fifth cluster C5, and a sixth vantage point associated with a sixth cluster C6. Two of the many outlier dots are indicated as O1 and O2.

More specifically, the zeroth vantage point is defined by numerous photographs taken proximate the Space Needle, itself, the first vantage point associated with the first cluster C1 can be a park (e.g., Kerry Park), the second vantage point associated with the second cluster C2 can be another park (e.g., Gas Works Park), the third vantage point associated with the third cluster C3 can be yet another park (e.g., Volunteer Park), the fourth vantage point associated with the fourth cluster C4 can be from an observation deck of a downtown Seattle building, the fifth vantage point associated with the fifth cluster C5 can be from a beach (e.g., Alki Beach), and the sixth vantage point associated with the sixth cluster C6 can be from a popular market (e.g., Pike's Place Market).

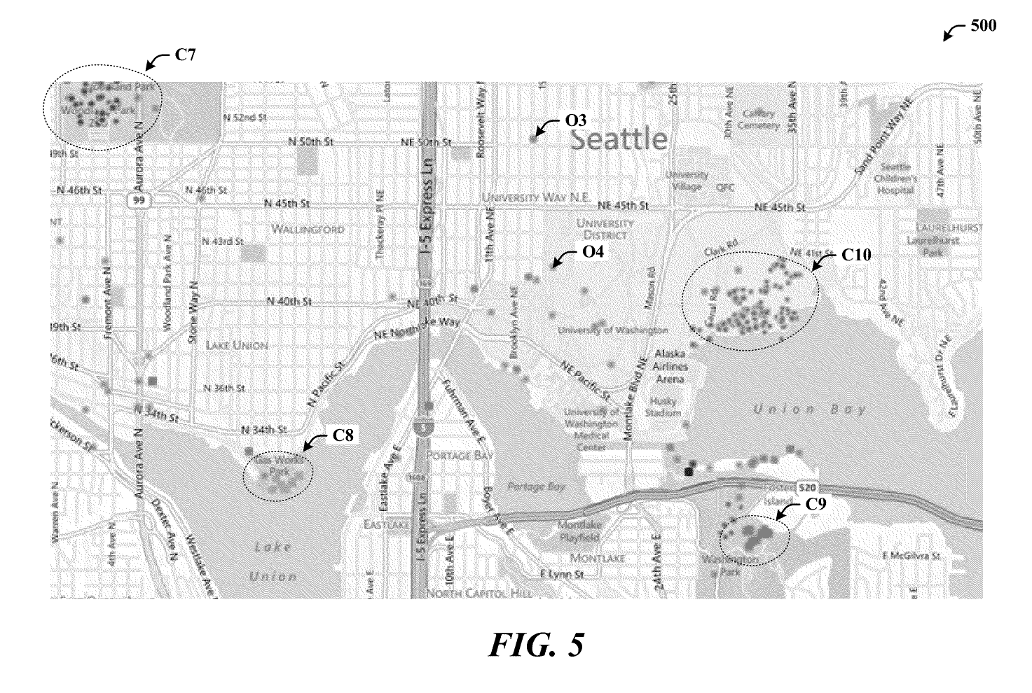

FIG. 5 illustrates a map 500 for the mining of viewsheds and vantage points for a concept entity based on geo-tagged “bird” data. Each dot on the map 500 represents a single instance of photo data. The architecture has identified four vantage points from which to view a “bird”: a seventh vantage point associated with a seventh cluster C7, an eighth vantage point associated with an eighth cluster C8, a ninth vantage point associated with a ninth cluster C9, a tenth vantage point associated with a tenth cluster C10. Two of the many outlier dots are indicated as O3 and O4. The clusters can be “activity” clusters where other users have captured images of the entity of interest, and which may be considered vantage points from which to obtain the desired photograph.

More specifically, the seventh vantage point associated with the seventh cluster C7 can be a zoo (e.g., Woodland Park Zoo), the eighth vantage point associated with the eighth cluster C8 can be a park (e.g., Gas Works Park), the ninth vantage point associated with the ninth cluster C9 can be another park (e.g., Washington Park Arboretum), the tenth vantage point associated with the tenth cluster C10 can be from a nature area (e.g., Union Bay Nature Area).

By developing a taxonomy based on clustering terms, suitable locations can be suggested to people in different interest groups. For example, the above vantage points for the “bird” tag can be offered to a bird-watching enthusiast, or more generally, to someone belonging to the “outdoorsy” interest category.

Concrete entities, abstract concepts, and associated relationships can also be rendered in the form of a graph that enables users to discover each of these. The graph construction can be based on mined histograms. For example, observation of a term frequency histogram of Skyline Park in Denver may reveal a high prevalence of the term “parkour” (a holistic training discipline). The fact that this location is a parkour spot is useful in itself, and the graph can also be utilized to show the user other parkour spots in Denver.

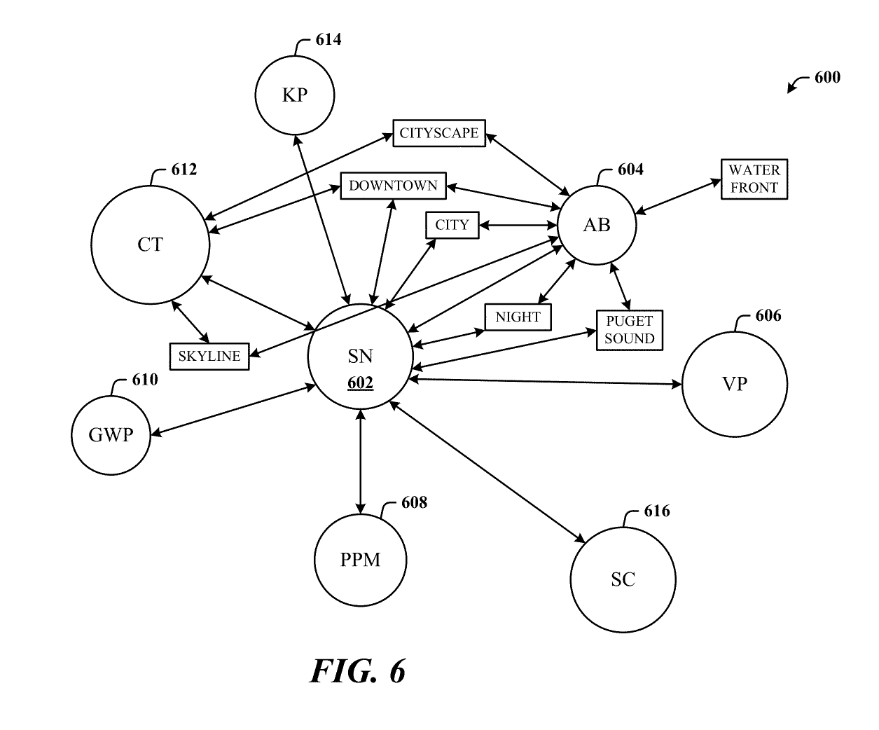

FIG. 6 illustrates a graph 600 that can be constructed based on term frequency histograms generated. The graph 600 comprises nodes and relationships for the physical location entity (entity of interest), vantage points as nodes, terms for the nodes, and links between one or more of the nodes and terms. All or parts of the graph 600 can be generated and presented to the user via a device display for viewing the nodes and relationships. Although depicted as double-headed arrows for bi-directional relationships and from which discovery can be from either node, it is to be understood that some relationships can be one-way (discoverable only from one node but not the other node to which the relationship exists).

Continuing with the “Space Needle” example, the graph 600 can comprise a node 602 for the entity of interest (“Space Needle” as SN), node 604 for Alki Beach (“AB”), node 606 for Volunteer Park (“VP”), a node 608 for Pike's Place Market (“PPM”), a node 610 for Gas Works (“GWP”), a node 612 for Columbia Tower (“CT”), a node 614 for Kerry Park (“KP”), and a node 616 for Seattle Center (“SC”). Other nodes and links (relationships) can be provided, but are not shown.

The graph generation procedure can then be repeated at each new node of the graph (using the location and/or top abstract terms) to reveal new related locations and terms. In the above example, graph expansion can be triggered at all nodes, except Space Needle (the graph's first originator node).

From the above graph, the user can gain insights, including, but not limited to, the following. Using social media, people generate information about the Space Needle (node 602) from the following locations: Columbia Tower (node 612), Kerry Park (node 614), Alki Beach (node 604), Volunteer Park (node 606), Seattle Center (node 616), Pike's Place Market (node 608), and Gas Works Park (node 610).

The graph 600 indicates that if the user visits the Space Needle, the user should probably check out these other locations as well. During the night (“night”), it might be nice to visit Alki Beach or the Space Needle. The user can observe the city (“city”) and the Puget Sound (“pugetsound”) from both locations.

If the user visits Alki Beach (node 604), the user may meet photographers who take pictures of the waterfront (“waterfront”) and cityscape (“cityscape”). Alki Beach (node 604) and Columbia Tower (node 612) are similar, because people generate data about the cityscape (“cityscape”), skyline (“skyline”), and downtown (“downtown”), from both locations. Accordingly, the user can probably get great views of the city from both locations (node 612 and node 604) Alki Beach (node 604) and the Space Needle (node 602) have many edges (links), not all of which are shown, but which indicate that people generate a lot of information about those locations; hence, the user should visit those locations first.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

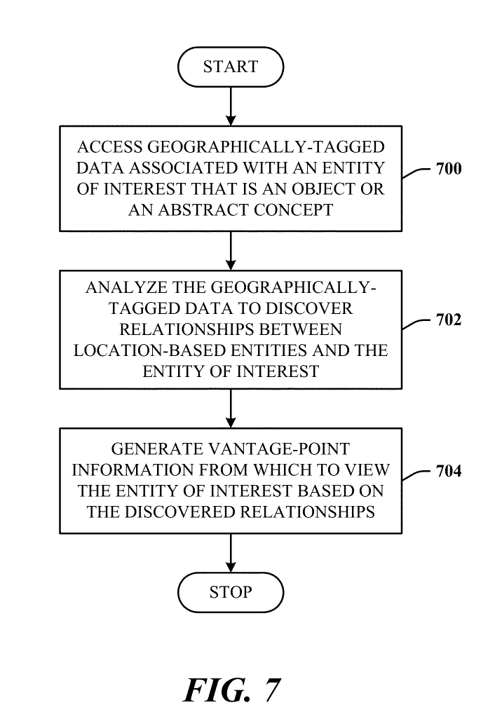

FIG. 7 illustrates a method in accordance with the disclosed architecture. At 700, geographically-tagged data is accessed as associated with an entity of interest that is an object or an abstract concept. At 702, the geographically-tagged data is analyzed to discover relationships between location-based entities and the entity of interest. At 704, vantage-point information is generated from which to view the entity of interest based on the discovered relationships.

The method can further comprise deriving conditions under which the relationships are active. The method can further comprise augmenting the vantage-point information with popularity data and source credibility data, as well as, or alternatively to, popularity and/or source credibility. The method can further comprise augmenting the relationships with emotional data associated with the geographically-tagged data.

The method can further comprise constructing and presenting hybrid graphs related to the entity of interest that enable discovery of new entities of interest. The method can further comprise recommending new entities of interest based on the relationships and relationship conditions. The method can further comprise recommending related entities of interest while exploring the entity of interest.

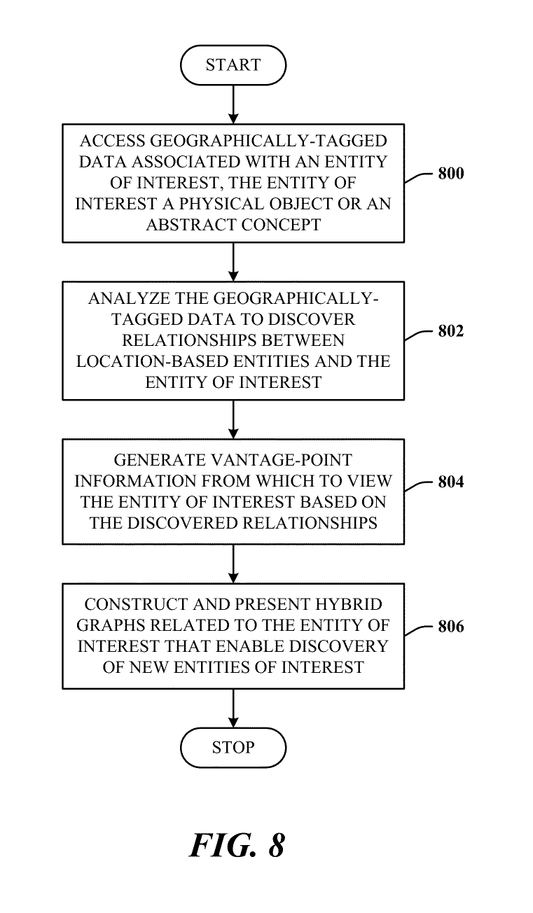

FIG. 8 illustrates an alternative method in accordance with the disclosed architecture. The method can be embodied as a computer-readable storage medium that comprises computer-executable instructions that when executed by a microprocessor, cause the microprocessor to perform acts of the method. At 800, geographically-tagged data associated with an entity of interest is accessed. The entity of interest can be a physical object or an abstract concept. At 802, the geographically-tagged data is analyzed to discover relationships between location-based entities and the entity of interest. At 804, vantage-point information from which to view the entity of interest is generated based on the discovered relationships. At 806, hybrid graphs related to the entity of interest are constructed and presented that enable discovery of new entities of interest.

The method can further comprise augmenting the vantage-point information with popularity data and source credibility data, and augmenting the relationships with emotional data associated with the geographically-tagged data. The method can further comprise recommending new entities of interest based on the relationships and relationship conditions. The method can further comprise recommending related entities of interest while exploring the entity of interest. The method can further comprise deriving conditions under which the relationships are active.

As used in this application, the terms “component” and “system” are intended to refer to a computer-related entity, either hardware, a combination of software and tangible hardware, software, or software in execution. For example, a component can be, but is not limited to, tangible components such as a microprocessor, chip memory, mass storage devices (e.g., optical drives, solid state drives, and/or magnetic storage media drives), and computers, and software components such as a process running on a microprocessor, an object, an executable, a data structure (stored in a volatile or a non-volatile storage medium), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

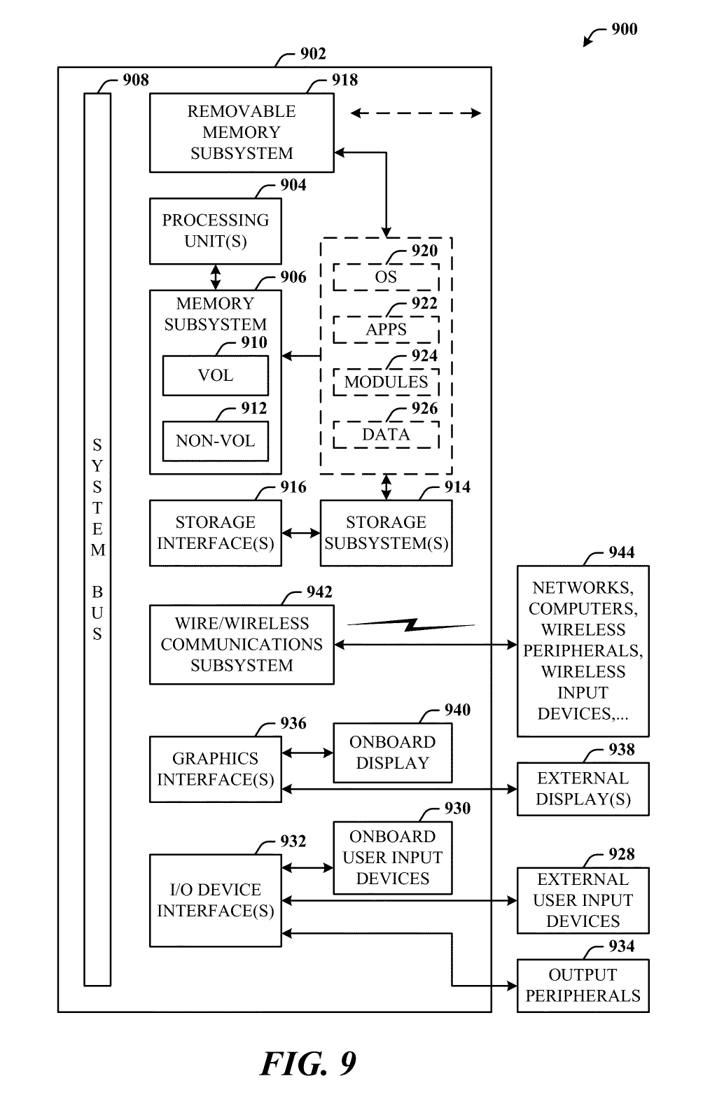

Referring now to FIG. 9, there is illustrated a block diagram of a computing system 900 that executes the discovery of viewsheds and vantage points by mining geo-tagged Data in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 9 and the following description are intended to provide a brief, general description of the suitable computing system 900 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 900 for implementing various aspects includes the computer 902 having microprocessing unit(s) 904 (also referred to as microprocessor(s) and processor(s)), a computer-readable storage medium such as a system memory 906 (computer readable storage medium/media also include magnetic disks, optical disks, solid state drives, external memory systems, and flash memory drives), and a system bus 908. The microprocessing unit(s) 904 can be any of various commercially available microprocessors such as single-processor, multi-processor, single-core units and multi-core units of processing and/or storage circuits. Moreover, those skilled in the art will appreciate that the novel system and methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 902 can be one of several computers employed in a datacenter and/or computing resources (hardware and/or software) in support of cloud computing services for portable and/or mobile computing systems such as wireless communications devices, cellular telephones, and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 906 can include computer-readable storage (physical storage) medium such as a volatile (VOL) memory 910 (e.g., random access memory (RAM)) and a non-volatile memory (NON-VOL) 912 (e.g., ROM, EPROM, EEPROM, etc.). A basic input/output system (BIOS) can be stored in the non-volatile memory 912, and includes the basic routines that facilitate the communication of data and signals between components within the computer 902, such as during startup. The volatile memory 910 can also include a high-speed RAM such as static RAM for caching data.

The system bus 908 provides an interface for system components including, but not limited to, the system memory 906 to the microprocessing unit(s) 904. The system bus 908 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 902 further includes machine readable storage subsystem(s) 914 and storage interface(s) 916 for interfacing the storage subsystem(s) 914 to the system bus 908 and other desired computer components and circuits. The storage subsystem(s) 914 (physical storage media) can include one or more of a hard disk drive (HDD), a magnetic floppy disk drive (FDD), solid state drive (SSD), flash drives, and/or optical disk storage drive (e.g., a CD-ROM drive DVD drive), for example. The storage interface(s) 916 can include interface technologies such as EIDE, ATA, SATA, and IEEE 1394, for example.

One or more programs and data can be stored in the memory subsystem 906, a machine readable and removable memory subsystem 918 (e.g., flash drive form factor technology), and/or the storage subsystem(s) 914 (e.g., optical, magnetic, solid state), including an operating system 920, one or more application programs 922, other program modules 924, and program data 926.

The operating system 920, one or more application programs 922, other program modules 924, and/or program data 926 can include items and components of the system 100 of FIG. 1, items and components of the system 200 of FIG. 2, items and flow of the diagram 300 of FIG. 3, the map 400 of FIG. 4, the map 500 of FIG. 5, the graph 600 and relationships of FIG. 6, and the methods represented by the flowcharts of FIGS. 7 and 8, for example.

Generally, programs include routines, methods, data structures, other software components, etc., that perform particular tasks, functions, or implement particular abstract data types. All or portions of the operating system 920, applications 922, modules 924, and/or data 926 can also be cached in memory such as the volatile memory 910 and/or non-volatile memory, for example. It is to be appreciated that the disclosed architecture can be implemented with various commercially available operating systems or combinations of operating systems (e.g., as virtual machines).

The storage subsystem(s) 914 and memory subsystems (906 and 918) serve as computer readable media for volatile and non-volatile storage of data, data structures, computer-executable instructions, and so on. Such instructions, when executed by a computer or other machine, can cause the computer or other machine to perform one or more acts of a method. Computer-executable instructions comprise, for example, instructions and data which cause a general purpose computer, special purpose computer, or special purpose microprocessor device(s) to perform a certain function or group of functions. The computer executable instructions may be, for example, binaries, intermediate format instructions such as assembly language, or even source code. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 902, and include volatile and non-volatile internal and/or external media that is removable and/or non-removable. For the computer 902, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 902, programs, and data using external user input devices 928 such as a keyboard and a mouse, as well as by voice commands facilitated by speech recognition. Other external user input devices 928 can include a microphone, an IR (infrared) remote control, a joystick, a game pad, camera recognition systems, a stylus pen, touch screen, gesture systems (e.g., eye movement, body poses such as relate to hand(s), finger(s), arm(s), head, etc.), and the like. The user can interact with the computer 902, programs, and data using onboard user input devices 930 such a touchpad, microphone, keyboard, etc., where the computer 902 is a portable computer, for example.

These and other input devices are connected to the microprocessing unit(s) 904 through input/output (I/O) device interface(s) 932 via the system bus 908, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 932 also facilitate the use of output peripherals 934 such as printers, audio devices, camera devices, and so on, such as a sound card and/or onboard audio processing capability.

One or more graphics interface(s) 936 (also commonly referred to as a graphics processing unit (GPU)) provide graphics and video signals between the computer 902 and external display(s) 938 (e.g., LCD, plasma) and/or onboard displays 940 (e.g., for portable computer). The graphics interface(s) 936 can also be manufactured as part of the computer system board.

The computer 902 can operate in a networked environment (e.g., IP-based) using logical connections via a wired/wireless communications subsystem 942 to one or more networks and/or other computers. The other computers can include workstations, servers, routers, personal computers, microprocessor-based entertainment appliances, peer devices or other common network nodes, and typically include many or all of the elements described relative to the computer 902. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 902 connects to the network via a wired/wireless communication subsystem 942 (e.g., a network interface adapter, onboard transceiver subsystem, etc.) to communicate with wired/wireless networks, wired/wireless printers, wired/wireless input devices 944, and so on. The computer 902 can include a modem or other means for establishing communications over the network. In a networked environment, programs and data relative to the computer 902 can be stored in the remote memory/storage device, as is associated with a distributed system. It will be appreciated that the network connections shown are exemplary and other means of establishing a communications link between the computers can be used.

The computer 902 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
an analysis component configured to analyze geographically-tagged data associated with an entity of interest and to discover relationships between location-based entities and the entity of interest, the entity of interest is an object or an abstract concept;
a view generation component configured to generate vantage-point information from which to view the entity of interest based on the discovered relationships; and
at least one microprocessor that executes computer-executable instructions in a memory associated with the analysis component and the view generation component.

2. The system of claim 1, wherein the geographically-tagged data is crowd-sourced image data.

3. The system of claim 1, further comprising an augmentation component configured to augment the vantage-point information with popularity data and source credibility data.

4. The system of claim 1, further comprising an augmentation component configured to augment the vantage-point information with emotional data derived from an association with the geographically-tagged data.

5. The system of claim 1, further comprising a recommendation component configured to recommend a new entity of interest based on the relationships and relationship conditions, as part of exploring the entity of interest.

6. The system of claim 1, further comprising a conditions component configured to detect at least one of spatial or temporal conditions under which the relationships are active.

7. The system of claim 1, further comprising a graphing component configured to generate graphs of entities of interest and relationships between the entities of interest to discover new entities.

8. The system of claim 1, wherein the geographically-tagged data is obtained from a social network and the analysis component employs machine-learning techniques to identify and de-noise the geographically tagged data.

9. A method, comprising acts of:
accessing geographically-tagged data associated with an entity of interest that is an object or an abstract concept;
analyzing the geographically-tagged data to discover relationships between location-based entities and the entity of interest; and
generating vantage-point information from which to view the entity of interest based on the discovered relationships.

10. The method of claim 9, further comprising deriving conditions under which the relationships are active.

11. The method of claim 9, further comprising augmenting the vantage-point information with popularity data and source credibility data.

12. The method of claim 9, further comprising augmenting the relationships with emotional data associated with the geographically-tagged data.

13. The method of claim 9, further comprising constructing and presenting hybrid graphs related to the entity of interest that enable discovery of new entities of interest.

14. The method of claim 9, further comprising recommending new entities of interest based on the relationships and relationship conditions.

15. The method of claim 9, further comprising recommending related entities of interest while exploring the entity of interest.

16. A computer-readable storage medium comprising computer-executable instructions that when executed by a microprocessor, cause the microprocessor to perform acts of:
accessing geographically-tagged data associated with an entity of interest, the entity of interest a physical object or an abstract concept;
analyzing the geographically-tagged data to discover relationships between location-based entities and the entity of interest;
generating vantage-point information from which to view the entity of interest based on the discovered relationships; and
constructing and presenting hybrid graphs related to the entity of interest that enable discovery of new entities of interest.

17. The computer-readable storage medium of claim 16, further comprising augmenting the vantage-point information with popularity data and source credibility data, and augmenting the relationships with emotional data associated with the geographically-tagged data.

18. The computer-readable storage medium of claim 16, further comprising recommending new entities of interest based on the relationships and relationship conditions.

19. The computer-readable storage medium of claim 16, further comprising recommending related entities of interest while exploring the entity of interest.

20. The computer-readable storage medium of claim 16, further comprising deriving conditions under which the relationships are active.
